(19) United States
(12) Patent Application Publication
(10) Pub. No.: US 2016/0109148 A1
(43) Pub. Date: Apr. 21, 2016

(54) TEMPERATURE DISTRIBUTION DISPLAY DEVICE AND METHOD

(71) Applicant: AZBIL CORPORATION, Chiyoda-ku (JP)

(72) Inventor: Mitsuhiro HONDA, Chiyoda-ku (JP)

(73) Assignee: AZBIL CORPORATION, Chiyoda-ku (JP)

(21) Appl. No.: 14/919,347

(22) Filed: Oct. 21, 2015

(30) Foreign Application Priority Data
Oct. 21, 2014 (JP) 2014-214376

(51) Int. Cl. F24F 11/00; G05B 15/02; G01J 5/10

(52) U.S. Cl. CPC F24F 11/006; G01J 5/10; G05B 15/02; G01J 2005/0077

(57) ABSTRACT

A temperature distribution display device is provided to make it possible to identify a person and framework easily and to make a temperature distribution comparison correctly among plural heat images. Based on space data regarding the size of an air-conditioned space and operation capability data regarding the operation capability of an air conditioner, a target temperature range calculation unit calculates a temperature range from a maximum heating start framework temperature, at which the air conditioner starts a heating operation at the maximum power autonomously, to a maximum cooling start framework temperature, at which the air conditioner starts a cooling operation at the maximum power autonomously, as a target temperature range, within the range of possible framework temperatures of the framework constituting interior planes of the air-conditioned space. A display color assignment unit assigns display colors respectively to individual temperatures included in the target temperature range.

### CROSS-REFERENCE TO RELATED APPLICATIONS

This application claims priority to Japanese Application No. 2014-214376, filed Oct. 21, 2014, the entire contents of which are incorporated herein by reference.

### FIELD

The disclosure relates to a temperature distribution display method, and more particularly to a display color assignment method for displaying a temperature distribution obtained from a heat image of an air-conditioned space on a screen with optimal display colors.

### BACKGROUND

Some air-conditioning systems have a function for air-conditioning a space moderately and efficiently by image-capturing the air-conditioned space by using an infrared image sensor, visualizing a temperature distribution obtained from a heat image that shows the surface temperature of the floor and walls of the air-conditioned space and objects that exist in the air-conditioned space, detecting whether a person is in the air-conditioned space or not and detecting the position of the person, and judging whether an air-conditioning operation is necessary or not, or performing an air-conditioning unit switchover. In some cases, on the basis of a visualized temperature distribution in the air-conditioned space, system changes, such as a change in an air outlet position, the addition of a ceiling fan, etc. are made after checking the imbalance of a heat load and air-conditioning control in the air-conditioned space.

As a method for evaluating a vehicle-mounted air-conditioning apparatus, a method of analyzing a temperature distribution in a vehicle cabin by executing a simulation, and visualizing the obtained temperature distribution, has been proposed in Japanese Unexamined Patent Application Publication No. 2002-373181. In this method, for color-to-temperature correspondences, for example, lower temperatures are shown in blue and green, and higher temperatures are shown in yellow and red.

When a temperature distribution in an air-conditioned space is visualized, the values of pixels that make up a heat image representing temperature are assigned respectively to display colors within a preset color range. It is generally considered that the temperature of a framework defining an air-conditioned space, for example, floor and walls, changes within a range from, e.g., −10 to 50° C. during four seasons. Therefore, on the basis of this framework temperature range, it is common to assign −10° C. to black, 50° C. to white, and temperatures therebetween to a color range from black to white in grayscale, or in color scale with continuous graduation.

In a display such as an LCD, display colors are expressed by means of red, green, and blue (RGB), which are the three primary colors of light. If each has a 256-scale brightness range, it is possible to express 256³=16,777,216 colors in color scale, or 256 colors in grayscale. Therefore, when the framework temperature, ranging from −10 to 50° C., is expressed by means of 256 colors in grayscale from black (RGB=0, 0, 0) to white (RGB=255, 255, 255), the temperature resolution per color is {50° C.−(−10° C.)}/256=0.23° C.

In general, the temperature of air supplied from an air-conditioning system to an air-conditioned space is not lower than approx. 15° C. during cooling and is not higher than approx. 40° C. during heating. Therefore, it is considered that the surface temperature of the framework defining an air-conditioned space and person(s) is almost always within the air-supply temperature range from 15 to 40° C.

However, the temperature width, 25° C., of the air-supply temperature range is roughly 40% of that of the framework temperature range, which is from −10 to 50° C. This means that, in a case of uniform color range assignment to the framework temperature range, roughly only 40% of the display colors in the entire color range are assigned to the air-supply temperature range, in which the surface temperature of a person and the framework is influenced. Consequently, there is a problem that the display colors are not effectively assigned to the surface temperature of a person and the framework, which is of interest in a temperature distribution.

One conceivable solution is to extract the lowest temperature and the highest temperature from a temperature distribution that is the target of visualization and to dynamically assign a color range not to the framework temperature range mentioned above, which is from −10 to 50° C., but to the temperature range from the lowest temperature to the highest temperature. However, assignment in this method is a relative assignment, meaning that the temperature range assigned differs from one heat image to another. Therefore, if the ambient temperature environment of an air-conditioned space differs to some extent, the entire temperature distribution range is affected. For this reason, despite the fact that the heat-image capturing was performed from an air-conditioned space, the same display color could represent different temperatures. Therefore, there is a problem in that it is not possible to make a temperature distribution comparison correctly among plural heat images.

The disclosure has been made in order to solve the problems described above. An object of the disclosure is to provide a temperature distribution display method that makes it possible to identify a person and a framework easily, and to make a temperature distribution comparison correctly among plural heat images.

### SUMMARY

According to one embodiment, there is provided a temperature distribution display device for color-coded display of, using plural preset display colors to make color-based distinctions, a temperature distribution represented by a heat image obtained by capturing an air-conditioned space, a room temperature of which is automatically controlled at a set temperature by an air-conditioning system, the device comprising (1) processing circuitry configured to (a) calculate, based on operation capability data regarding an operation capability of the air-conditioning system, a temperature range extending from a maximum heating start framework temperature, at which the air-conditioning system starts a heating operation at maximum power autonomously, to a maximum cooling start framework temperature, at which the air-conditioning system starts a cooling operation at maximum power autonomously, as a target temperature range to be displayed in a color-coded manner, within a range of possible framework temperatures of a framework constituting interior planes of the air-conditioned space, and (b) assign the plural preset display colors respectively to individual temperatures included in the target temperature range; and (2) a temperature distribution display configured to display the temperature distribution in the color-coded manner based on the display colors assigned by the processing circuitry.

### BRIEF DESCRIPTION OF THE DRAWINGS

FIG. 1 is a block diagram that illustrates the structure of the temperature distribution display device;

FIG. 2 is a flowchart that illustrates temperature distribution display processing;

FIG. 3 is a diagram for explaining the assignment of display colors;

FIG. 4 is a diagram that shows an example of the color-coded display of a temperature distribution according to a conventional method; and

FIG. 5 is a diagram that shows an example of the color-coded display of a temperature distribution according to one embodiment.

### DETAILED DESCRIPTION

To achieve the objects described above, a temperature distribution display device, which is a device for color-coded display of, by means of plural preset display colors to make color-based distinctions, a temperature distribution represented by a heat image obtained by capturing an air-conditioned space, a room temperature of which is automatically controlled at a set temperature by an air-conditioning system, comprises: a target temperature range calculation unit that calculates, on the basis of operation capability data regarding operation capability of the air-conditioning system, a temperature range from a maximum heating start framework temperature, at which the air-conditioning system starts a heating operation at maximum power autonomously, to a maximum cooling start framework temperature, at which the air-conditioning system starts a cooling operation at maximum power autonomously, as a target temperature range, which should be displayed in a color-coded manner, within a range of possible framework temperatures that framework constituting interior planes of the air-conditioned space can take; a display color assignment unit that assigns the display colors respectively to individual temperatures included in the target temperature range; and a temperature distribution display unit that displays the temperature distribution in a color-coded manner on the basis of the assignment of the display colors.

In one structural example of the above temperature distribution display device according to one embodiment, the target temperature range calculation unit calculates, as the maximum heating start framework temperature, the framework temperature in an air-conditioned environment in which an amount of heat supplied from the air-conditioning system is equal to an amount of heat generated from the framework when a limit heating set temperature, which denotes an upper limit during heating, is set within a temperature range settable as the set temperature for the air-conditioning system, and calculates, as the maximum cooling start framework temperature, the framework temperature in an air-conditioned environment in which an amount of heat supplied from the air-conditioning system is equal to an amount of heat generated from the framework when a limit cooling set temperature, which can be set during cooling in the set temperature, is set.

In one structural example of the above temperature distribution display device according to one embodiment, the target temperature range calculation unit calculates a temperature range from a lowest temperature of air that can be supplied from the air-conditioning system to the air-conditioned space in the operation capability data to a highest temperature of air that can be supplied from the air-conditioning system to the air-conditioned space in the operation capability data, as the target temperature range, instead of calculating the temperature range from the maximum heating start framework temperature to the maximum cooling start framework temperature.

A temperature distribution display method according to one embodiment, which is a method for color-coded display of, by means of plural preset display colors to make color-based distinctions, a temperature distribution represented by a heat image obtained by capturing an air-conditioned space, a room temperature of which is automatically controlled at a set temperature by an air-conditioning system, comprises: a target temperature range calculation step of calculating, on the basis of operation capability data regarding operation capability of the air-conditioning system, a temperature range from a maximum heating start framework temperature, at which the air-conditioning system starts a heating operation at maximum power autonomously, to a maximum cooling start framework temperature, at which the air-conditioning system starts a cooling operation at maximum power autonomously, as a target temperature range, which should be displayed in a color-coded manner, within a range of possible framework temperatures that framework constituting interior planes of the air-conditioned space can take; a display color assignment step of assigning the display colors respectively to individual temperatures included in the target temperature range; and a temperature distribution display step of displaying the temperature distribution in a color-coded manner on the basis of the assignment of the display colors.

In the disclosure, preset display colors are assigned to the range of possible framework temperatures suitable for a framework in a state in which an air-conditioned environment in an air-conditioned space is practically controllable, wherein the air-conditioned controllable-state range is narrower than the range of possible changes in the framework temperature of the air-conditioned space during four seasons.

Therefore, when a temperature distribution represented by a heat image obtained by capturing the air-conditioned space is displayed in a color-coded manner, it is possible to intensively assign a larger number of display colors to a meaningful temperature range under air-conditioning control. This makes it possible to identify temperature differences easily. Moreover, when a color-coded temperature distribution display is performed for different heat images, if the target air-conditioned space is the same, display color assignment is performed in the same manner. Therefore, it is possible to make a temperature distribution comparison correctly among plural heat images.

When the surface temperature of a person who is in an air-conditioned space is visualized in the form of a temperature distribution on the basis of a heat image obtained by capturing the air-conditioned space by using an infrared image sensor together with the surface temperature of framework constituting interior planes of the air-conditioned space, for example, the floor and walls thereof, the question as to how plural preset display colors should be assigned to temperature steps in a temperature range has a significant influence on the visibility of the visualized temperature distribution. If the preset display colors are assigned to respective temperature steps in the range of possible changes in the framework temperature of an air-conditioned space during four seasons, that is, in the aforementioned framework temperature range from −10 to 50° C., the range of possible temperatures that the surface temperature of a person can take within said framework temperature range is narrow. In some cases, this makes it difficult to find the position of the person.

The idea of using, as the target temperature range for display color assignment, the range of possible changes in the framework temperature of an air-conditioned space during four seasons is based on an expectation that the temperature of the framework defining the air-conditioned space changes in the possible temperature range of the ambient environment, by which the air-conditioned space is surrounded. Therefore, in this idea, it is presupposed that a temperature distribution that is the target of visualization encompasses a temperature distribution in a state in which an air-conditioning system is not in operation.

However, an air-conditioning system is a system for realizing a comfortable air-conditioned environment for a person who is in an air-conditioned space, and the object of visualizing a temperature distribution obtained from a heat image is to check a temperature distribution inside the air-conditioned space in a state in which the air-conditioning system is in operation. Therefore, it is not necessary to take the visualization of a temperature distribution in a state in which the air-conditioning system is not in operation.

Unlike conventional systems, with a focus on the fact that the object of visualizing a temperature distribution obtained from a heat image is the visualization of a temperature distribution in a state in which an air-conditioning system is in operation, in the present disclosure, preset display colors are assigned to respective temperature steps in the temperature range of a framework under the control of the air-conditioning system, that is, a target temperature range, instead of a framework temperature range encompassing a state in which an air-conditioning system is not in operation.

An air-conditioning system controls a room temperature inside an air-conditioned space into a set temperature automatically. However, there is a limit in the operation capability of an air-conditioning system. Moreover, its performance is influenced by the size of the air-conditioned space. Therefore, though an air-conditioning system increases its operational power toward its maximum operation capability gradually as a room temperature decreases during heating, if the room temperature further decreases, it goes beyond a controllable range, meaning that even the maximum heating is not enough. Though an air-conditioning system increases its operation power toward its maximum operation capability gradually as a room temperature increases during cooling, if the room temperature further increases, it goes beyond a controllable range, meaning that even the maximum cooling is not enough.

When not within a controllable range, an air-conditioning system is operating at its maximum power. Since an air-conditioned environment in an air-conditioned space is not practically controllable in this state, it is not necessary to visualize a temperature distribution inside the air-conditioned space and to check the operation state of the air-conditioning system.

With a focus on the above relationship between the operation capability of an air-conditioning system and a state beyond a controllable range, in the present disclosure, a temperature range from a maximum heating start framework temperature, at which an air-conditioning system starts a heating operation at maximum power autonomously, to a maximum cooling start framework temperature, at which the air-conditioning system starts a cooling operation at maximum power autonomously, is calculated as a target temperature range, to be displayed in a color-coded manner, within a range of possible framework temperatures.

Next, with reference to the drawings, an exemplary embodiment of the present disclosure is explained below.

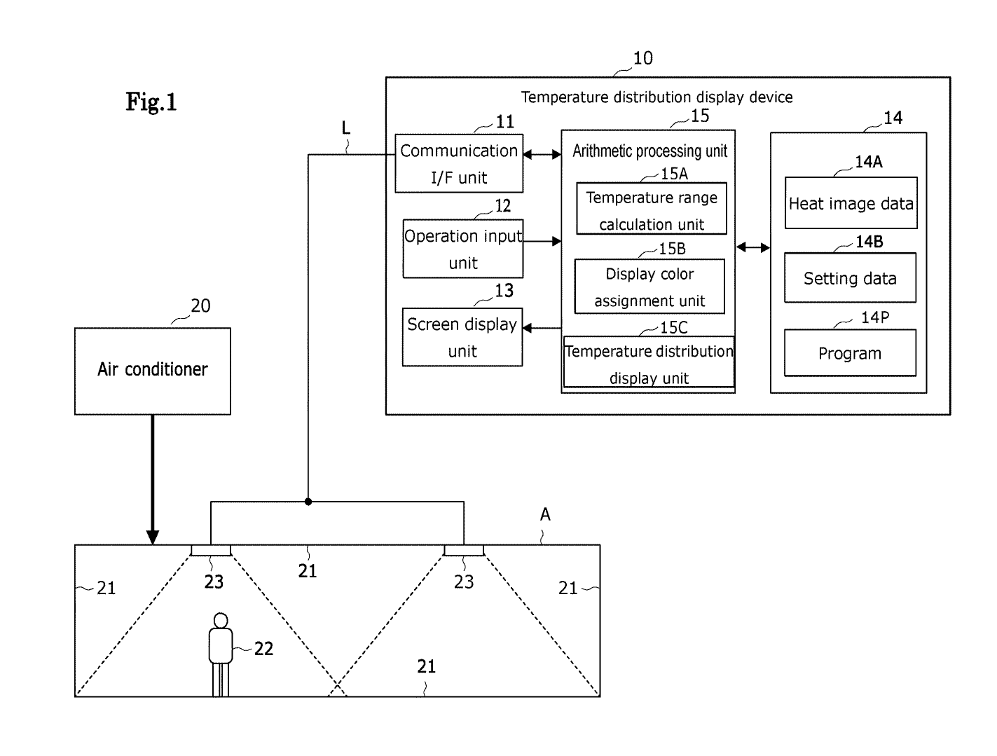

First, with reference to FIG. 1, a temperature distribution display device 10 according to the present disclosure will now be explained. FIG. 1 is a block diagram that illustrates the structure of the temperature distribution display device.

The temperature distribution display device 10 as a whole is an information processing device such as a server or a personal computer. This device has a color-coded display function of, using plural preset display colors to make color-based distinctions, displaying a temperature distribution represented by a heat image obtained by capturing an air-conditioned space A, the room temperature of which is automatically controlled at a set temperature by an air conditioner 20.

The air conditioner 20 is an ordinary air-conditioning system. The air conditioner 20 has a function of automatically controlling the room temperature of the air-conditioned space A at a set temperature by supplying conditioning air generated by a heat exchanger to the air-conditioned space A.

Framework 21, which defines the air-conditioned space A, is made up of walls, a floor, and a ceiling, etc. A person 22 and objects, such as a table, exist inside the air-conditioned space A. An infrared image sensor (or sensors) 23 is installed on the ceiling of the air-conditioned space A. A heat image captured by the infrared image sensor 23 is transmitted to the temperature distribution display device 10 via a communication channel L. The heat image represents a temperature distribution in the air-conditioned space A.

The temperature distribution display device 10 includes, as its major functional units, a communication I/F unit 11, an operation input unit 12, a screen display unit 13, a memory 14, and an arithmetic processing unit 15.

The communication I/F unit 11 has a function of performing data communication with the infrared image sensor 23 via the communication channel L, thereby receiving the heat image captured by the infrared image sensor 23 representing the temperature distribution in the air-conditioned space A.

The operation input unit 12 is an operation input device such as a keyboard, a mouse, or a touch panel, and has a function of detecting an operation performed by an operator and outputting it to the arithmetic processing unit 15.

The screen display unit 13 is a screen display device such as an LCD, and has a function of displaying various kinds of data, for example, temperature distribution data and an operation menu outputted from the arithmetic processing unit 15.

The memory 14 is a memory device such as a hard disk or a semiconductor memory, and has a function of storing various kinds of processing data and program 14P used in the arithmetic processing unit 15.

The program 14P is run by the CPU of the arithmetic processing unit 15 for implementation of various processing modules for temperature distribution display processing. The CPU is an example of processing circuitry. The program 14P is pre-stored in the memory 14 from an external device or a storage medium via the communication I/F unit 11.

Major processing data stored in the memory 14 includes heat image data 14A and setting data 14B.

The heat image data 14A is the data of the heat image captured by the infrared image sensor 23 representing the temperature distribution in the air-conditioned space A. In this data, pixel values that make up the image show the surface temperature of the framework 21 and the person 22 in the air-conditioned space A.

The setting data 14B is data that is necessary when temperature distribution display processing is performed at the arithmetic processing unit 15. The setting data 14B is preset into the memory 14 by an operator by means of the operation input unit 12. The setting data 14B includes space data, operation capability data, and display color data, etc. The space data is data regarding the size of the air-conditioned space A, including vertical size data, horizontal size data, and height data, etc. of the air-conditioned space A. The operation capability data is data regarding the operation capability of the air conditioner 20, including maximum air supply volume data, heating air supply temperature data, cooling air supply temperature data, limit heating set temperature data, and limit cooling set temperature data, etc.

The display color data is data regarding display colors used for color-coded display of a temperature distribution. The color range and the set of display colors are preset by using the color data. For example, for color coding in color scale, color data made up of respective brightness values of color elements such as RGB or CMY is used. For color coding in grayscale, color data made up of black-and-white brightness values is used.

The arithmetic processing unit 15 includes a CPU and its peripheral circuitry, and has a function of implementing various processing modules for temperature distribution display processing by reading and executing the program 14P stored in the memory 14.

Major processing modules implemented by the arithmetic processing unit 15 include a target temperature range calculation unit 15A, a display color assignment unit 15B, and a temperature distribution display unit 15C.

The target temperature range calculation unit 15A has a function of calculating a temperature range from a maximum heating start framework temperature Tmh, at which the air conditioner 20 starts a heating operation at the maximum power autonomously, to a maximum cooling start framework temperature Tmc, at which the air conditioner 20 starts a cooling operation at the maximum power autonomously, as a target temperature range Tw, which should be displayed in a color-coded manner, on the basis of the set operation capability data regarding the operation capability of the air conditioner 20 in the setting data 14B stored in the memory 14, within the range of possible framework temperatures of a framework constituting interior planes of the air-conditioned space A.

More specifically, the target temperature range calculation unit 15A has a function of calculating, as the maximum heating start framework temperature Tmh, a framework temperature in an air-conditioned environment in which an amount of heat supplied from the air conditioner 20 is equal to an amount of heat generated from the framework 21 when a limit heating set temperature Trh, which denotes an upper limit during heating, is set within a temperature range settable as a set temperature for the air conditioner 20, and a function of calculating, as the maximum cooling start framework temperature Tmc, a framework temperature in an air-conditioned environment in which an amount of heat supplied from the air conditioner 20 is equal to an amount of heat generated from the framework when a limit cooling set temperature Trc, which can be set during cooling in the set temperature, is set.

The display color assignment unit 15B has a function of assigning display colors respectively to individual temperatures included in the target temperature range Tw calculated by the target temperature range calculation unit 15A on the basis of the display color data set in the setting data 14B stored in the memory 14. The display colors are assigned respectively to temperature steps obtained by dividing the target temperature range Tw by the number of the display colors. For example, if the target temperature range Tw has a temperature width corresponding to 16° C., and if the number of display colors is 256, each one color is assigned to a temperature step corresponding to 0.0625° C.

The temperature distribution display unit 15C has a function of displaying the temperature distribution of the heat image data 14A stored in the memory 14 in a color-coded manner on the basis of the assignment of the display colors by the display color assignment unit 15B, a function of displaying the color-coded temperature distribution on the screen display unit 13, and a function of transmitting temperature distribution display data that represents the color-coded temperature distribution to the outside via the communication I/F unit 11.

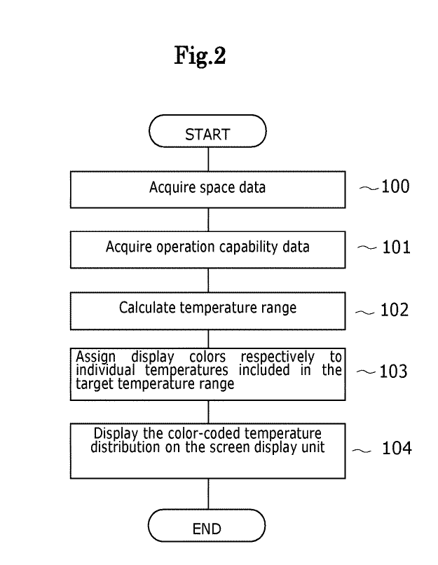

Next, with reference to FIG. 2, the operation of the temperature distribution display device 10 according to one embodiment will now be explained. FIG. 2 is a flowchart that illustrates temperature distribution display processing.

The arithmetic processing unit 15 of the temperature distribution display device 10 executes the temperature distribution display processing illustrated in FIG. 2 in response to temperature distribution display instructions given by an operator and detected at the operation input unit 12. For execution of the temperature distribution display processing, it is assumed that the heat image data 14A, which has been acquired from the infrared image sensor 23 via the communication I/F unit 11, is pre-stored in the memory 14, and that the setting data 14B is preset therein in accordance with an operator's operation.

First, the target temperature range calculation unit 15A acquires space data from the setting data 14B stored in the memory 14 (Step 100), and, next, acquires operation capability data from the setting data 14B (Step 101). On the basis of the space data and the operation capability data, the target temperature range calculation unit 15A calculates a temperature range from the maximum heating start framework temperature Tmh, at which the air conditioner 20 starts heating operation at the maximum power autonomously, to the maximum cooling start framework temperature Tmc, at which the air conditioner 20 starts a cooling operation at the maximum power autonomously, as the target temperature range Tw, which should be displayed in a color-coded manner, within the range of possible framework temperatures of the framework constituting interior planes of the air-conditioned space A (Step 102).

In general, the sum of an amount of heat supplied from an air-conditioning system and an amount of heat generated in an air-conditioned space is equal to a change in the amount of heat in the air-conditioned space. Therefore, because of the principle of conservation of energy, Formula (1) below expresses the state of an air-conditioned space.

$$C ρ V \frac{d Tr ( t )}{d t} = C ρw \{ Ts ( t ) \} + {\sum }_{x} KxAx \{ Tmx ( t ) - Tr ( t ) ] \qquad ( 1 )$$

In Formula (1), C denotes the specific heat of air (approximately equal to) 1006 [J/(Kg·° C.)]; ρ denotes the density of air≈1.2 [Kg/m³]; V denotes volume [m³]; w denotes the flow volume of air supplied to the air-conditioned space [m³/s]; Tr denotes set temperature; Ts denotes air supply temperature; Kx denotes the convective heat transfer coefficient of the ordinal x-th framework 9 [W/(m²·K)]; Ax denotes the area size of the ordinal x-th framework; and Tmx denotes the average surface temperature of the ordinal x-th framework.

Let us assume that there is no change in an air-conditioned environment in an air-conditioned space and that the surface temperature of each piece of framework is Tm. Let K be the convective heat transfer coefficient of each piece of framework≈9 [W/(m²K·)]. Let A be the total area size of all pieces of framework. Given these definitions, Formula (1) can be simplified into the following Formula (2).

Cρw{Ts(t)−Tr(t)}+KxAx{Tmx(t)−Tr(t)}=0 (2)

Therefore, the surface temperature Tm of each piece of framework can be calculated using the following Formula (3).

$$Tm = Tr + \frac{Cpw ( Tr - Ts )}{KA} \qquad ( 3 )$$

In the above formula, it is possible to consider the maximum heating start framework temperature Tmh, at which the air conditioner 20 starts heating operation at the maximum power autonomously, as a framework temperature in an air-conditioned environment in which an amount of heat supplied from the air conditioner 20 is equal to an amount of heat generated from the framework 21 when the limit heating set temperature Trh, which denotes an upper limit during heating, is set as set temperature for the air conditioner 20.

Therefore, for example, if the size of the air-conditioned space A is preset to 10 m×20 m×3 m (vertical×horizontal×height) in the space data, and if, in the operation capability data, the maximum air supply volume to 4000 [m³/s], the heating air supply temperature Tsh to 40[° C.], and the limit heating set temperature Trh to 20[° C.], the maximum heating start framework temperature Tmh, at which the air conditioner 20 starts heating operation at the maximum power autonomously, can be calculated using the following Formula (4), specifically, Tmh=14.9 [° C.].

$$\begin{matrix}Tmh = 20 + \frac{1006 \times .2 \times ( 4000 / 3600 ) \times ( 20 - 40 )}{9.0 \times ( 3 \times 10 + 3 \times 20 + 20 \times 10 ) \times 2} \\ = 14.9 {[}^{°} C . ]\end{matrix} \qquad ( 4 )$$

In addition, it is possible to consider the maximum cooling start framework temperature Tmc, at which the air conditioner 20 starts a cooling operation at the maximum power autonomously, as a framework temperature in an air-conditioned environment in which an amount of heat supplied from the air conditioner 20 is equal to an amount of heat generated from the framework 21 when the limit cooling set temperature Trc is set as a set temperature for the air conditioner 20.

Therefore, for example, if the size of the air-conditioned space A is preset to 10 m×20 m×3 m (vertical×horizontal×height) in the space data, and if, in the operation capability data, the maximum air supply volume to 4000 [m³/s], the cooling air supply temperature Tsc to 15[° C.], and the limit cooling set temperature Trc to 28[° C.], the maximum cooling start framework temperature Tmc, at which the air conditioner 28 starts a cooling operation at the maximum power autonomously, can be calculated using the following Formula (5), specifically, Tmc=31.3 [° c.].

$$\begin{matrix}Tmc = 28 + \frac{1006 \times .2 \times ( 4000 / 3600 ) \times ( 28 - 15 )}{9.0 \times ( 3 \times 10 + 3 \times 20 + 20 \times 10 ) \times 2} \\ = 31.3 {[}^{°} C . ]\end{matrix} \qquad ( 5 )$$

Next, the display color assignment unit 15B assigns display colors respectively to individual temperatures included in the target temperature range Tw calculated by the target temperature range calculation unit 15A on the basis of the display color data set in the setting data 14B stored in the memory 14 (Step 103).

Then, the temperature distribution display unit 15C displays the temperature distribution of the heat image data 14A stored in the memory 14 in a color-coded manner on the basis of the assignment of the display colors by the display color assignment unit 15B, and displays the color-coded temperature distribution on the screen display unit 13 (Step 104) to end a series of the temperature distribution display processing.

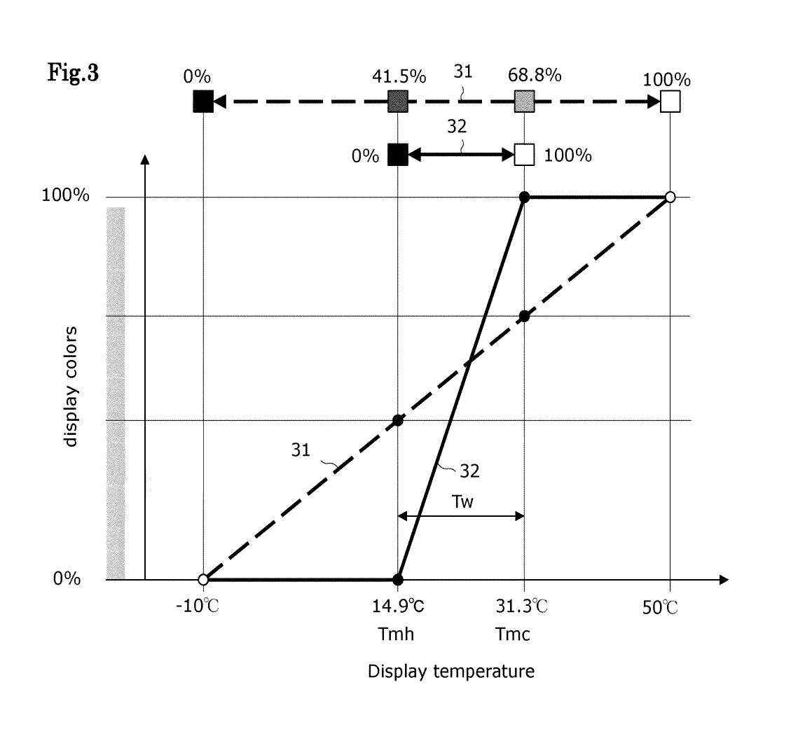

FIG. 3 is a diagram for explaining the assignment of display colors. In FIG. 3, the horizontal axis represents the values of pixels that make up a heat image, that is, display temperature, and the vertical axis represents display colors assigned to the respective values of display temperature. It is assumed here that an arbitrary color range is preset for the display colors, and the display colors from the minimum value to the maximum value of the range are expressed in display color change percentage, from 0% (black) to 100% (white). Though the illustrated percentage expression is in a grayscale, it is not limited thereto and it may be in a color scale.

If the aforementioned framework temperature range, that is, from −10 to 50° C., which is the range of possible changes in framework temperature during four seasons, is set as the target temperature range for display color assignment based on the aforementioned conventional method, the display color of change 0% (black) is assigned to −10° C., and the display color of change 100% (white) is assigned to 50° C. Therefore, this display color assignment is expressed as characteristics 31.

In contrast, if the framework temperature range from the maximum heating start framework temperature Tmh to the maximum cooling start framework temperature Tmc is as the target temperature range Tw, the display color of change 0% (black) is assigned to Tmh, and the display color of change 100% (white) is assigned to Tmc. Therefore, this display color assignment is expressed as characteristics 32. In the calculation example of Tmh=14.9° C. and Tmc=31.3° C. described above, according to the characteristics 31, the display color of change 41.5% is assigned to Tmh, and the display color of change 68.8% is assigned to Tmc.

For this reason, within the range of possible framework temperatures Twh−Tmc, which the framework 21 can take in a state in which an air-conditioned environment in an air-conditioned space is practically controllable, a color-coded display in the conventional method is performed using display colors corresponding to a change width of 27.3% only, whereas a color-coded display in one embodiment of the disclosure is performed using display colors corresponding to a change width of 100%, resulting in the use of a larger number of display colors for the color-coded display.

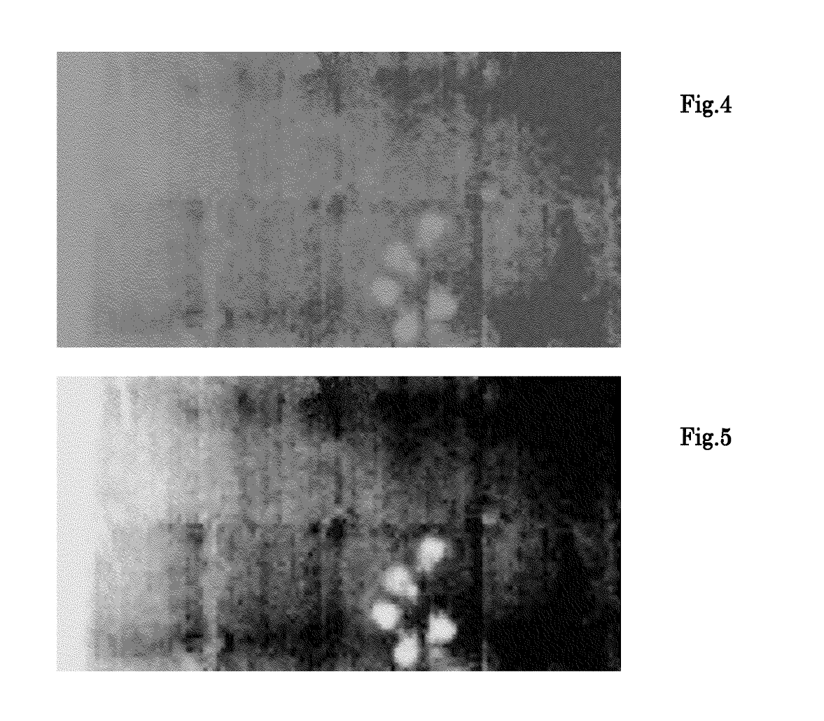

FIG. 4 is a diagram that shows an example of the color-coded display of a temperature distribution according to the conventional method. FIG. 5 is a diagram that shows an example of the color-coded display of a temperature distribution according to one embodiment discussed herein. In FIGS. 4 and 5, the color-coded display of the same temperature distribution in the air-conditioned space A in which there are five persons 22 are shown. As can be seen from a comparison of FIGS. 4 and 5, in the present disclosure, a larger number of display colors are used for the color-coded display. This makes it possible to identify the framework 21 and the persons 22 easily.

As described above, in the present disclosure, on the basis of the space data regarding the size of the air-conditioned space A and on the basis of the operation capability data regarding the operation capability of the air conditioner 20, the target temperature range calculation unit 15A calculates a temperature range from the maximum heating start framework temperature Tmh, at which the air conditioner 20 starts a heating operation at the maximum power autonomously, to the maximum cooling start framework temperature Tmc, at which the air conditioner 20 starts a cooling operation at the maximum power autonomously, as the target temperature range Tw, which should be displayed in a color-coded manner, within the range of possible framework temperatures of the framework 21 constituting interior planes of the air-conditioned space A.

More specifically, the target temperature range calculation unit 15A calculates, as the maximum heating start framework temperature Tmh, a framework temperature in a steady state in which an amount of heat supplied from the air conditioner 20 is equal to an amount of heat generated from the framework 21 when the limit heating set temperature Trh, which denotes an upper limit during heating, is set within a temperature range settable as a set temperature for the air conditioner 20, and calculates, as the maximum cooling start framework temperature Tmc, a framework temperature in a steady state in which an amount of heat supplied from the air conditioner 20 is equal to an amount of heat generated from the framework 21 when the limit cooling set temperature Trc, which can be set during cooling in the set temperature, is set.

Preset display colors are assigned to the range of possible framework temperatures Twh−Tmc for the framework 21 in a state in which the air-conditioned environment in the air-conditioned space A is practically controllable, wherein the air-conditioned controllable-state range is narrower than the range of possible changes in the framework temperature of the air-conditioned space A during four seasons.

Therefore, when a temperature distribution represented by a heat image obtained by capturing the air-conditioned space A is displayed in a color-coded manner, it is possible to intensively assign a larger number of display colors to a meaningful temperature range in air-conditioning control. This makes it possible to identify the framework 21 and the person 22 easily. Moreover, when a color-coded temperature distribution display is performed for different heat images, if the target air-conditioned space A is the same, display color assignment is performed for the same target temperature range in the same manner. Therefore, it is possible to make a temperature distribution comparison correctly among plural heat images.

In the present embodiments, a case in which the temperature range from the maximum heating start framework temperature Tmh to the maximum cooling start framework temperature Tmc is calculated as the target temperature range Tw is explained above as an example. However, a temperature range from the cooling air supply temperature Tsc to the heating air supply temperature Tsh preset in the operation capability data may be calculated as the target temperature range Tw.

In general, the cooling air supply temperature Tsc is the lowest temperature value of air supplied from the air conditioner 20 at the maximum power during cooling. Air, the temperature of which is lower than this temperature, is never supplied from the air conditioner 20. Accordingly, the value of the lowest framework temperature under air-conditioning control is closely based on Tsc. The heating air supply temperature Tsh is the highest temperature value of air supplied from the air conditioner 20 at the maximum power during heating. Air, the temperature of which is higher than this temperature, is never supplied from the air conditioner 20. Accordingly, the value of the highest framework temperature under air-conditioning control is closely based on Tfh.

Therefore, if the temperature range from the cooling air supply temperature Tsc to the heating air supply temperature Tsh is taken as the target temperature range Tw, it is possible to calculate the target temperature range Tw with very simple processing, though the temperature range is wider than in a case where the temperature range from the maximum heating start framework temperature Tmh to the maximum cooling start framework temperature Tmc is taken as the target temperature range Tw.

Though the present disclosure is explained above by means of exemplary embodiments, the disclosure is not limited to the above embodiments. The structure and details of the disclosure can be modified in various manners that can be apprehended by those skilled in the art, within the scope of the disclosure. The embodiments may be combined arbitrarily as long as they are not contradictory.

1. A temperature distribution display device for color-coded display of, using plural preset display colors to make color-based distinctions, a temperature distribution represented by a heat image obtained by capturing an air-conditioned space, a room temperature of which is automatically controlled at a set temperature by an air-conditioning system, the device comprising:
processing circuitry configured to
calculate, based on operation capability data regarding an operation capability of the air-conditioning system, a temperature range extending from a maximum heating start framework temperature, at which the air-conditioning system starts a heating operation at maximum power autonomously, to a maximum cooling start framework temperature, at which the air-conditioning system starts a cooling operation at maximum power autonomously, as a target temperature range to be displayed in a color-coded manner, within a range of possible framework temperatures of a framework constituting interior planes of the air-conditioned space, and
assign the plural preset display colors respectively to individual temperatures included in the target temperature range; and
a temperature distribution display configured to display the temperature distribution in the color-coded manner based on the display colors assigned by the processing circuitry.

2. The temperature distribution display device of claim 1, wherein the processing circuitry is further configured to
calculate, as the maximum heating start framework temperature, a first framework temperature in an air-conditioned environment in which an amount of heat supplied from the air-conditioning system is equal to an amount of heat generated from the framework when a limit heating set temperature, which denotes an upper limit during heating, is set within a temperature range settable as the set temperature for the air-conditioning system, and
calculate, as the maximum cooling start framework temperature, a second framework temperature in the air-conditioned environment in which the amount of heat supplied from the air-conditioning system is equal to an amount of heat generated from the framework when a limit cooling set temperature is set.

3. The temperature distribution display device of claim 2, wherein the processing circuitry is configured to calculate the first framework temperature as a sum of the limit heating set temperature and a term that is proportional to a difference between the limit heating set temperature and a heating air supply temperature.

4. A temperature distribution display device for color-coded display of, using plural preset display colors to make color-based distinctions, a temperature distribution represented by a heat image obtained by capturing an air-conditioned space, a room temperature of which is automatically controlled at a set temperature by an air-conditioning system, the device comprising:
processing circuitry configured to
calculate, based on operation capability data regarding an operation capability of the air-conditioning system, a temperature range extending from a lowest temperature of air that can be supplied from the air-conditioning system to the air-conditioned space, to a highest temperature of air that can be supplied from the air-conditioning system to the air-conditioned space, as the target temperature range to be displayed in a color-coded manner, within a range of possible framework temperatures of a framework constituting interior planes of the air-conditioned space, and
assign the plural preset display colors respectively to individual temperatures included in the target temperature range; and
a temperature distribution display configured to display the temperature distribution in the color-coded manner based on the display colors assigned by the processing circuitry.

5. A temperature distribution display method for color-coded display of, using plural preset display colors to make color-based distinctions, a temperature distribution represented by a heat image obtained by capturing an air-conditioned space, a room temperature of which is automatically controlled at a set temperature by an air-conditioning system, the method comprising:
calculating, based on operation capability data regarding an operation capability of the air-conditioning system, a temperature range extending from a maximum heating start framework temperature, at which the air-conditioning system starts a heating operation at maximum power autonomously, to a maximum cooling start framework temperature, at which the air-conditioning system starts a cooling operation at maximum power autonomously, as a target temperature range to be displayed in a color-coded manner, within a range of possible framework temperatures of a framework constituting interior planes of the air-conditioned space;
assigning the plural preset display colors respectively to individual temperatures included in the target temperature range; and
displaying the temperature distribution in a color-coded manner based on the assigned display colors.

6. The temperature distribution display method of claim 5, wherein the calculating step further comprises
calculating, as the maximum heating start framework temperature, a first framework temperature in an air-conditioned environment in which an amount of heat supplied from the air-conditioning system is equal to an amount of heat generated from the framework when a limit heating set temperature, which denotes an upper limit during heating, is set within a temperature range settable as the set temperature for the air-conditioning system, and
calculating, as the maximum cooling start framework temperature, a second framework temperature in the air-conditioned environment in which the amount of heat supplied from the air-conditioning system is equal to an amount of heat generated from the framework when a limit cooling set temperature is set.

7. The temperature distribution display method of claim 6, wherein the step of calculating the first framework temperature comprises calculating the first framework temperature as a sum of the limit heating set temperature and a term that is proportional to a difference between the limit heating set temperature and a heating air supply temperature.

8. A non-transitory computer-readable medium storing a program which, when executed by processing circuitry, causes the processing circuitry to perform a temperature distribution display method for color-coded display of, using plural preset display colors to make color-based distinctions, a temperature distribution represented by a heat image obtained by capturing an air-conditioned space, a room temperature of which is automatically controlled at a set temperature by an air-conditioning system, the method comprising:
calculating, based on operation capability data regarding an operation capability of the air-conditioning system, a temperature range extending from a maximum heating start framework temperature, at which the air-conditioning system starts a heating operation at maximum power autonomously, to a maximum cooling start framework temperature, at which the air-conditioning system starts a cooling operation at maximum power autonomously, as a target temperature range to be displayed in a color-coded manner, within a range of possible framework temperatures of a framework constituting interior planes of the air-conditioned space;
assigning the plural preset display colors respectively to individual temperatures included in the target temperature range; and
displaying the temperature distribution in a color-coded manner based on the assigned display colors.

9. The computer-readable medium of claim 8, wherein the calculating step further comprises
calculating, as the maximum heating start framework temperature, a first framework temperature in an air-conditioned environment in which an amount of heat supplied from the air-conditioning system is equal to an amount of heat generated from the framework when a limit heating set temperature, which denotes an upper limit during heating, is set within a temperature range settable as the set temperature for the air-conditioning system, and
calculating, as the maximum cooling start framework temperature, a second framework temperature in the air-conditioned environment in which the amount of heat supplied from the air-conditioning system is equal to an amount of heat generated from the framework when a limit cooling set temperature is set.

10. The computer-readable medium of claim 9, wherein the step of calculating the first framework temperature comprises calculating the first framework temperature as a sum of the limit heating set temperature and a term that is proportional to a difference between the limit heating set temperature and a heating air supply temperature.
